(19) United States
(12) Patent Application Publication
(10) Pub. No.: US 2020/0143455 A1
(43) Pub. Date: May 7, 2020

(54) SIGNALLING METHOD, CORRESPONDING WINDSCREEN WIPER SEARCHING SYSTEM AND PACKAGING

(71) Applicant: Valeo Systemes D'Essuyage, La Verriere (FR)

(72) Inventors: Antoine Boilevin, Bobigny (FR); Stephane Ballanger, Saint Denis (FR); Emeric Bailleul, Saint Denis (FR); Guillaume Ingold, Saint Denis (FR); Olivier Jomard, Issoire (FR); Felix Marquette, Bobigny (FR); Maria Pelissero, Saint Denis (FR); Eric Poton, Issoire (FR); Marc Senaux, Issoire (FR)

(21) Appl. No.: 16/607,552

(22) PCT Filed: Apr. 25, 2018
(86) PCT No.: PCT/EP2018/060554

§ 371 Date: Oct. 23, 2019

(30) Foreign Application Priority Data
Apr. 28, 2017 (FR) 1753821

(51) Int. Cl. G06Q 30/06

(52) U.S. Cl. CPC G06Q 30/0643; G06Q 30/0639; G06Q 30/0631

(57) ABSTRACT

The invention relates to a method and system for signaling or identifying at least one windscreen wiper on a shelf, using at least one search interface and at least one identification parameter so as to identify at least one windscreen wiper compatible with a motor vehicle.

The present invention relates to a method for signaling at least one windshield wiper reference compatible with a given motor vehicle model among a plurality of windshield wipers stored on a shelf with the aid of a system for searching for windshield wiper references. The invention also relates to a system for searching for windshield wiper references for implementing such a method and also to packaging for windshield wipers that allows the signaling of a reference. The invention applies also to a shelf of windshield wipers in a store.

Conventionally, a windshield wiper may be supplied to customers from a shelf in a store prior to being fitted onto a vehicle windshield wiping system.

For sale from shelving, the windshield wipers or pairs of windshield wipers are generally packed in packaging, for example a box, of elongate general form.

However, a user seeking a compatible windshield wiper for the model of his/her motor vehicle may encounter a number of difficulties in finding the correct windshield wiper reference on the store shelving. Indeed, it may be difficult to find the correct reference because many windshield wiper references are similar and all the motor vehicle models for which windshield wipers are compatible, notably more recent models, are not necessarily indicated on the packaging of these windshield wipers.

It is known to search via an interactive terminal for a reference for a given vehicle model. However, it is then necessary to find this reference on the shelving, notably amid a plurality of stock display prongs.

Furthermore, when the customer has made his/her choice and has been able to identify the necessary reference, he/she may still be unsure as to the choice made.

An object of the invention is to palliate this drawback by proposing a signaling method and a searching system that make it possible to facilitate searching for and locating the correct reference for a given vehicle model.

To this end, a subject of the invention is a method for signaling at least one windshield wiper reference that is compatible with a given motor vehicle model among a plurality of windshield wipers stored on a shelf, with the aid of a windshield wiper reference searching system, comprising:
at least one search interface, and
at least one database of data relating to the windshield wiper references on the shelf and their compatibility with a plurality of motor vehicle models,

said method comprising the following steps:
at least one identification parameter of a motor vehicle model for which at least one windshield wiper is sought is input via said at least one search interface,
said at least one database is interrogated such as to identify at least one windshield wiper reference compatible with the motor vehicle model of which the identity was established with the aid of said at least one identification parameter,
at least one information item relating to said at least one windshield wiper reference identified is sent to the search interface.

According to the invention, said method further comprises the following steps:
at least one signaling device borne by the windshield wiper(s) of the identified reference and/or borne by the shelf is detected, said at least one signaling device comprising a light-emitting device, and
the light-emitting device of said at least one detected signaling device is controlled such that it emits at least one luminous signal enabling a user to locate the windshield wiper(s) of the identified reference or to note the absence on the shelf of a windshield wiper of the identified reference.

According to one or more features of the method, taken alone or in combination:
the step of detecting said at least one signaling device and the step of controlling the light-emitting device are implemented by a control unit of the searching system,
the step of interrogating said at least one database and the step of sending at least one information item to the search interface are implemented by the control unit of the searching system,
the light-emitting device is controlled such that it flashes,
during the step of detecting said at least one signaling device, a reader of the control unit emits radiofrequencies such as to communicate with a radio-identification marker belonging to a windshield wiper identification data support of said at least one signaling device;
said method comprises the following steps: at least two windshield wiper references compatible with the motor vehicle model of which the identity has been established with the aid of said at least one identification parameter, and which are from different ranges, are identified, and the light-emitting devices of the signaling devices associated with the references of windshield wipers in the different ranges are controlled such that they emit a different luminous signal in accordance with the range;
said method comprises a plurality of steps of inputting via a plurality of search interfaces and a plurality of steps of interrogating said at least one database:
at each interrogation step, at least one windshield wiper reference compatible with the motor vehicle model of which the identity has been established with the aid of said at least one identification parameter is identified,
at least one information item relating to the identified reference is sent to the associated search interface;
the light-emitting devices are controlled such that they emit a different luminous signal in accordance with the reference;
the light-emitting devices emit luminous signals in different colors;
at least one information item relating to the color associated with at least one windshield wiper reference is displayed on the search interface;
the light-emitting devices emit luminous signals in accordance with different flashing rates;
at least one information item relating to the flashing rate associated with at least one windshield wiper reference is displayed on the search interface;
said method allows the signaling of at least one windshield wiper reference compatible with a given motor vehicle model among a plurality of windshield wipers stored on stock display prongs on the shelving, and, in the detection step, at least one signaling device borne by a stock display prong dedicated to storing windshield wipers of the identified reference is detected;
the luminous signal is emitted in accordance with a predefined timing;
said at least one identification parameter is chosen among the list of parameters: trade name, vehicle registration document, license plate number.

A further subject of the invention is a system for searching for windshield wiper references compatible with a given motor vehicle model among a plurality of windshield wipers on a shelf, the searching system being configured such as to implement the method as described above, and comprising:
at least one search interface configured for the inputting of at least one identification parameter of a motor vehicle model for which a user is seeking at least one windshield wiper, and
at least one database of data relating to the windshield wiper references on the shelf and their compatibility with a plurality of motor vehicle models.

The searching system further comprises:
a control unit comprising at least one processing means:
   for communicating with said at least one search interface and said at least one database such as to identify at least one windshield wiper reference compatible with the motor vehicle model of which the identity has been established with the aid of said at least one identification parameter,
   for communicating with a plurality of signaling devices borne by the windshield wipers and/or by the shelf such as to detect at least one signaling device of the identified reference, and
   for commanding a light-emitting device of said at least one detected signaling device.

According to one aspect of the invention, the light-emitting device is a light-emitting diode.

According to another aspect of the invention, the search interface belongs to a mobile terminal. Alternately, the search interface belongs to a terminal of the interactive terminal type.

According to yet another aspect, said at least one database is a local database of the interactive terminal. In this case, the searching system is the interactive terminal. Alternately, said at least one database belongs to a central server with which the control unit is configured to communicate.

Said at least one database may comprise information on range and price associated with the windshield wiper references.

According to a particular embodiment, the searching system is adapted to search for windshield wipers compatible with a given motor vehicle model among a plurality of windshield wipers stored on stock display prongs on the shelving.

A further subject of the invention is packaging configured such as to receive a windshield wiper for a motor vehicle and such as to be stored on a shelf. The packaging comprises a signaling device, the signaling device comprising an identification data support and at least one light-emitting device, such that:
the identification data support comprises at least one information item on the windshield wiper reference, and
the light-emitting device is configured to emit a luminous signal such as to enable a user to locate the windshield wiper of this reference.

According to one aspect of the invention, the signaling device is integrated into an anti-theft security device affixed to the packaging of the windshield wiper.

A further subject of the invention is a shelf for storing windshield wipers in accordance with their references, comprising a plurality of signaling devices each comprising an identification data support and at least one light-emitting device. The identification data support comprises at least one information item on the reference of the windshield wipers borne by the stock display prong. The light-emitting device is configured such as to emit a luminous signal so as to enable a user to locate the windshield wipers of this reference or to note the absence of a windshield wiper of the identified reference.

According to one aspect of the invention, the shelf comprises a plurality of stock display prongs for storing windshield wipers in accordance with their references. The stock display prongs each comprise a signaling device comprising an identification data support and at least one light-emitting device. For each stock display prong, the identification data support comprises at least one information item on the reference of the windshield wipers borne by the stock display prong. The light-emitting device is configured such as to emit a luminous signal so as to enable a user to locate the windshield wipers of this reference.

Further features and advantages of the invention will become more clearly apparent on reading the following description, which is given by way of illustrative example and is non-limiting, and the appended drawings, in which:

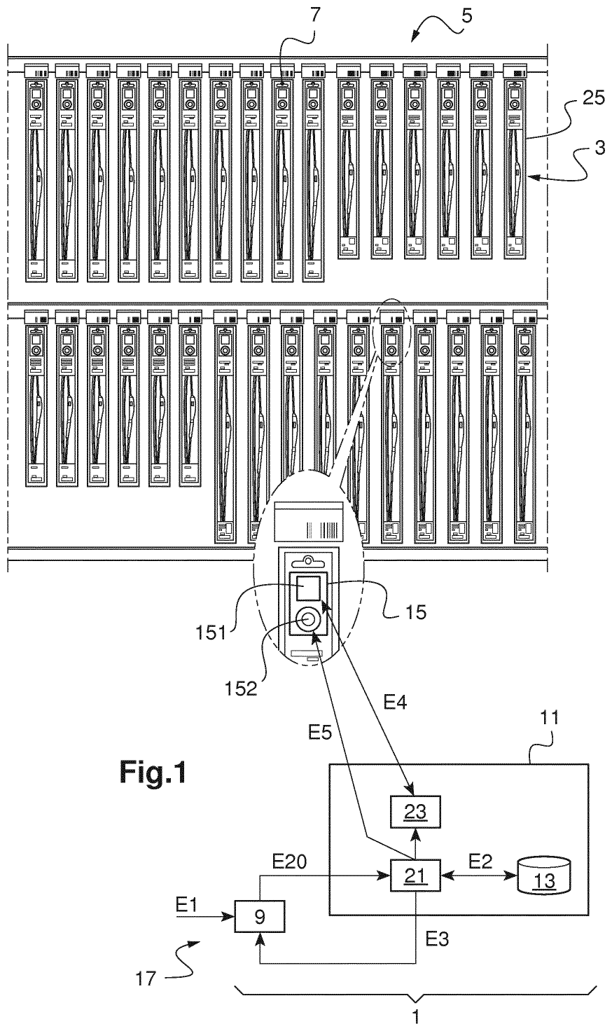

FIG. 1 shows in a schematic and simplified manner a system for searching for windshield wiper references, which is configured such as to communicate with signaling devices associated with windshield wipers stored on a shelf,

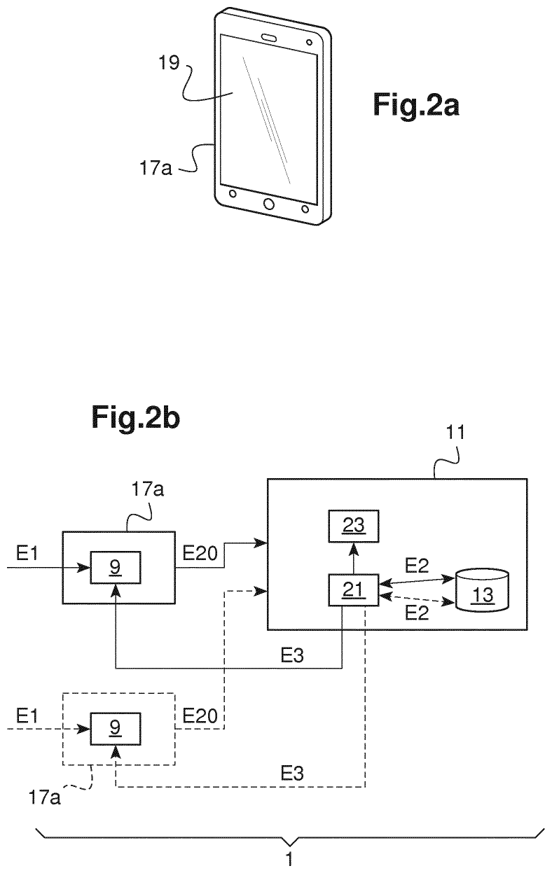

FIG. 2a shows an example of a mobile terminal for the searching system of FIG. 1,

FIG. 2b shows in a schematic and simplified manner an example of communications between mobile terminals and a control unit of the searching system,

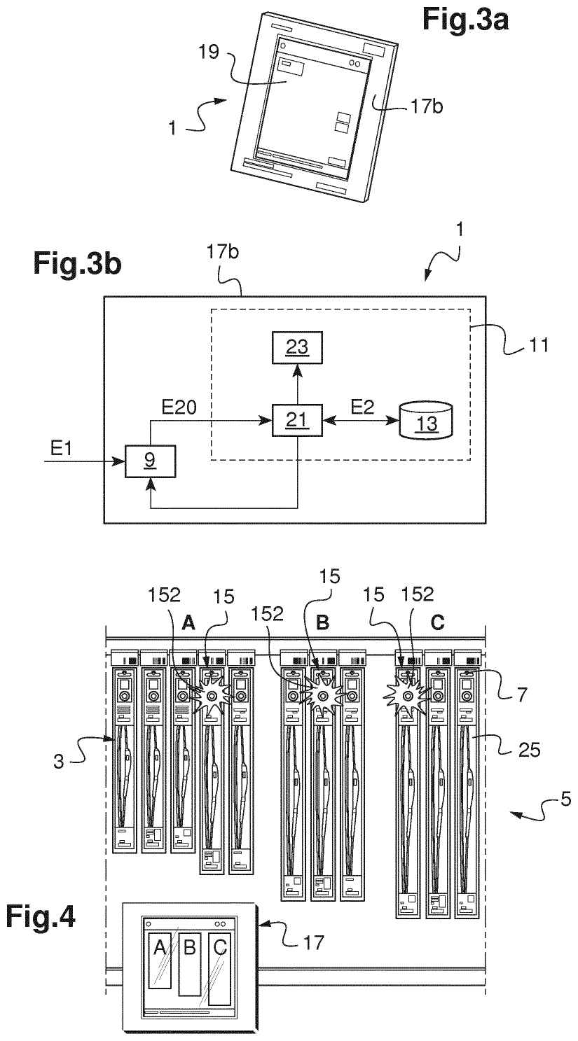

FIG. 3a shows an example of a fixed terminal for the searching system of FIG. 1,

FIG. 3b shows in a schematic and simplified manner an illustrative embodiment of the fixed terminal comprising the control unit of the searching system, and

FIG. 4 shows in a schematic and simplified manner an example of signaling of windshield wipers of different ranges compatible with a motor vehicle model for which a user is seeking a windshield wiper.

In these figures, identical or similar elements are identified by the same reference numbers.

The following embodiments are examples. Although the description makes reference to one or more embodiments, this does not necessarily mean that each reference relates to the same embodiment or that the features apply only to a single embodiment. Simple features of different embodiments may likewise be combined or interchanged in order to provide other embodiments.

The invention relates to a signaling method and a system 1 enabling a user in a store easily to locate one or more windshield wiper 3 references compatible with the model of his/her motor vehicle or, alternately, rapidly to note the absence of these windshield wiper 3 references.

### System

FIG. 1 schematically shows a system 1 for searching for windshield wiper 3 references.

This is a system 1 that makes it possible to search for windshield wiper references compatible with a given motor vehicle model among a plurality of windshield wipers 3. These windshield wipers 3 are stored on a shelf 5 in a store. According to the illustrative embodiment shown, the windshield wipers 3 are borne on stock display prongs 7 on the shelving 5. In this example, storage is on vertical shelving. Naturally, other variants of storage on the shelving 5 may be envisaged. By way of non-limiting example, provision may be made to store the windshield wiper blades 3 flat on the shelving 5.

The searching system 1 is configured such as to implement a method for signaling at least one windshield wiper 3 reference, as described below.

The searching system 1 comprises notably:
at least one search interface 9,
a control unit 11, and
at least one database 13.

At least one element of the searching system 1 is configured such as to establish a communication with a plurality of signaling devices 15 which are associated with the windshield wipers 3 stored on the shelving 5 and which can light up, for example flash, in the wake of a command from the control unit 11, as detailed below.

Different components of the searching system 1 are described in greater detail below.

The search interface 9 is part of a terminal 17. “Terminal” 17 is understood to be any type of equipment capable of exchanging data, requests, messages and other content with the control unit 11.

It may, for example, be a mobile terminal 17a, such as a cellular telephone or “smart phone”, or, alternately, a tablet, as indicated schematically in FIGS. 2a, 2b.

In a variant, it may be a fixed terminal 17b, such as an automaton of interactive terminal type, as shown schematically in FIGS. 3a, 3b, which is located in the store, generally close to the windshield wipers 3.

With reference to FIGS. 1, 2b and 3b, the search interface 9 enables the user to access an application or computer program or software or, alternately, a website, offering the user a windshield wiper 3 search service.

The search interface 9 comprises hardware enabling exchanges between a user and the control unit 11.

Conventionally, the search interface 9 comprises a display screen 19 (see FIGS. 2a and 3a). This may optionally be a touch-sensitive screen. The search interface 9 may comprise, according to a variant, a keyboard that enables the user to input at least one parameter identifying a motor vehicle model for which he/she is searching for at least one windshield wiper 3. If the display screen 19 is a touch-sensitive screen, the user is able to input or to enter the identification parameter or parameters directly from the touch-sensitive screen 19.

The or each identification parameter is, for example, chosen among the list of parameters as follows: a trade name, an identification number such as is found on vehicle registration documents, or, alternately, a license plate number.

The search interface 9 comprises one or more processing means configured such as to communicate with the control unit 11.

More precisely, the search interface 9 may comprise at least one processing means for emitting at least one information item to the control unit 11, and this may be the or each identification parameter of the motor vehicle model as input or as converted into a suitable request format for interrogating the database(s) 13. According to another illustrative embodiment that is not shown, the search interface 9 could comprise one or more processing means or software that makes it possible directly to interrogate the database(s) 13.

The search interface 9 may comprise at least one processing means for receiving at least one information item associated with a windshield wiper 3 reference identified as compatible with the motor vehicle model for which a windshield wiper 3 is being sought, i.e. the motor vehicle model of which the identity has been established with the aid of the one or more identification parameters.

Advantageously, the display screen 19 (shown schematically in FIGS. 2a and 3a) of the search interface 9 makes it possible to display the information item or items associated with a windshield wiper 3 reference compatible with this identified given motor vehicle model.

The control unit 11 may form part of the terminal 17, in particular when this is a fixed interactive terminal 17b, as shown schematically in a very simplified manner in FIG. 3b. When the control unit 11 is not part of the terminal 17, it may be part of a workstation arranged in the store close to the windshield wipers 3.

The control unit 11 comprises at least one processing means 21 for communicating with the search interface 9 or with each search interface 9 (see FIGS. 1, 2b, 3b).

In particular, the control unit 11 may comprise at least one processing means 21 for receiving at least one information item originating from the search interface 9 or from each search interface 9. The control unit 11 may optionally comprise, also, at least one processing means 21 for converting the information item received into a compatible request format for interrogating the database(s) 13.

The control unit 11 may further comprise at least one processing means 21 or software for communicating with the database(s) 13, notably making it possible to interrogate the or each database 13, such as to identify at least one windshield wiper 3 reference compatible with the user's motor vehicle model, i.e. of which the identity has been established with the aid of the one or more identification parameters.

The control unit 11 may also comprise at least one processing means 21 for sending at least one information item associated with a windshield wiper 3 reference to the search interface 9 or to each search interface 9.

Advantageously, the information item sent is optionally previously in or converted by appropriate software into a format compatible with the display on the search interface 9.

When a plurality of searches are carried out from different mobile terminals 17a, either simultaneously or within a short predefined period of time, the control unit 11 may comprise a counting or memory means for temporarily storing the number of requests received simultaneously or in a short predefined period of time.

According to a particular embodiment, a plurality of windshield wiper references for different ranges may be compatible for a given search. In other words, with reference to FIG. 4, there may be a top-of-the-range A windshield wiper 3 reference, another, mid-range B windshield wiper 3 reference, and, yet again, another, bottom-of-the-range C windshield wiper 3 reference. In this case, with reference, also, to FIGS. 1, 2b, 3b, the control unit 11 may comprise at least one processing means 21 configured such as to determine the different signaling parameters in accordance with range A, B or C. For example:
the signaling device 15 corresponding to the top-of-the-range A windshield wiper 3 reference may light up or flash in a first color,
the signaling device 15 corresponding to the mid-range B windshield wiper 3 reference may light up or flash in a second color that is different from the first color, and
the signaling device 15 corresponding to the bottom-of-the-range C windshield wiper 3 reference may light up or flash in a third color that is different from the first color and from the second color.

In a variant, or complementarily, at least one processing means 21 of the control unit 11 may be configured such as to determine different flashing rates in accordance with range A, B or C.

In the present text, “at least one processing means 21 of the control unit 11” is understood to mean one or more means such as an electronic power component or a program or software making it possible to analyze information items received and/or to transmit signals to other components of the searching system 1.

In particular, when a plurality of searches are carried out simultaneously or in a short predefined period of time, the control unit 11 may comprise at least one processing unit 21 for determining and attributing signaling parameters specific to each search.

In other words, at least one processing means of the control unit 11 may be configured such as to determine a color or a set of colors for the illumination of the signaling devices 15 corresponding to the references extracted for each request. In a variant, or complementarily, at least one processing means of the control unit 11 may be configured such as to determine a flashing rate specific to the signaling means 15 corresponding to the references identified in response to each search.

The control unit 11 may further comprise at least one processing means 21 for emitting an information item relating to the signaling parameters to the search interface 9 or to each search interface 9.

The control unit 11 further comprises at least one processing means 23 configured such as to communicate with each signaling device 15 so as to recognize the signaling devices 15 corresponding to the windshield wipers 3 of which the references have been identified in response to the interrogation of the database(s) 13. In other words, this makes it possible to detect the signaling device(s) borne by the windshield wipers 3 having the reference identified after interrogation of the database(s) 13 and/or borne by the shelving 5, and also, for example, borne by the stock display prong 7 dedicated to storage of the windshield wipers 3 of this identified reference.

This may be an electronic chip contactless reader or tags of the signaling devices 15.

The connection between the control unit 11 and the signaling devices 15 may be a wired connection when the control unit 11 is arranged close to the shelving 5 where the windshield wipers 3 are stored.

In a variant, the connection may be a wireless connection, for example using radiowave communication, such as in accordance with the Bluetooth protocol, or, alternately, a WiFi connection.

The control unit 11 also comprises at least one processing means for controlling the illumination of the signaling device(s) 15 detected.

The or each database 13 (see FIGS. 1, 2b, 3b) stores data relating to the windshield wiper 3 references on the shelving 5 and their compatibility with a plurality of motor vehicle models. To this end, the or each database 13 may comprise a table of correspondence between the models of motor vehicles on the market and the referenced windshield wipers 3 stored on the shelving 5.

The database(s) 13 may comprise information items on range and price associated with the windshield wiper 3 references.

The database(s) 13 make it possible to extract at least one windshield wiper 3 reference compatible with the or each motor vehicle model of which the identity has been established at the time of each search with the aid of one or more identification parameters.

According to a particular embodiment, the or each database 13 makes it possible to identify or to extract a plurality of windshield wiper 3 references of different ranges A, B or C (with reference, also, to FIG. 4).

Furthermore, the database(s) 13 may make it possible to identify or to extract one or more references for different searches.

One or more databases 13 may be local and belong to the control unit 11 or to the terminal 17, in particular when the terminal 17 is a fixed interactive terminal 17b.

In a variant, there may be one or more databases 13 of one central server with which the control unit 11 is configured to communicate. In this latter case, the control unit 11 may comprise means for connection to the server that are activated, for example, in the event of receiving information items originating from one or more search interfaces 9.

Thus, when the terminal 17 is implemented in the form of an interactive terminal 17b, this terminal comprises, with reference to FIGS. 3a and 3b:
the search interface 9 comprising a screen 19, advantageously a touch-sensitive screen, such that the client is able to enter one or more parameters identifying the motor vehicle model, and
the control unit 11 comprising:
   at least one processing means 21 for connecting to, and more precisely for interrogating, the or each database 13 when said database is not local, or, in a variant, for allowing communication between the search interface 9 and the database(s) 13 when the interactive terminal 17 comprises the database(s) 13, and
   at least one processing means 23 for communicating with the signaling devices 13.

In this embodiment, the searching system 1 is formed by the interactive terminal 17.

When the terminal 17 is a mobile terminal, such as a cellular telephone 17a, in this case the control unit 11 is not part of the terminal 17 but may be part of a fixed workstation or fixed computer arranged close to the shelving 5 for the windshield wipers 3.

With reference, once again, to FIG. 1, the signaling devices 15 may, for their part, be arranged on each windshield wiper 3, more precisely on the packaging 25 of each windshield wiper 3 designed to be stored on a stock display prong 7 of the shelving 5.

The signaling devices 15 may be integrated into an anti-theft security device affixed to each packaging 25.

In a variant, or complementarily, the signaling devices 15 may be on the shelving 5, for example arranged on each stock display prong 7 on the shelving 5.

The signaling devices 15 each comprise an identification data support 151 for a windshield wiper reference.

By way of non-limiting example, the identification data support 151 may comprise a radio identification marker. This is thus, notably, a radiofrequency tag, known as an RFID (“Radiofrequency IDentification”) tag. In the remainder of the description, the RFID acronym is used to denote radio identification. The RFID tag comprises a transponder in the form of an electronic chip and a communication antenna such as to allow contactless communication between the content of the electronic chip and a suitable reader. In this case, the processing means 23 of the control unit 11 comprises an RFID reader.

The signaling devices 15 also comprise at least one light-emitting device 152, such as a light-emitting diode. The light-emitting diodes may be controlled by the control unit 11 such as to emit a luminous signaling enabling a user to locate the windshield wipers 3 of a given reference. The light-emitting diodes may illuminate in different colors by mixing the red, green and blue value.

This may make it possible, also, for the user to note the absence of a windshield wiper 3 of the identified reference on the shelving 5, notably where no light-emitting device 152 emits a luminous signal, or if the stock display prong(s) 7 carrying the light-emitting diodes that are illuminated are empty or free.

Furthermore, in particular where a plurality of searches are possible at the same time, at least one processing means 21 of the control unit 11 may be configured such as to send a control signal to the light-emitting diode(s) comprising the distribution of red, green and blue according to the reference.

### Method

With reference to the figures as a whole, a description is given below of a method for signaling at least one windshield wiper 3 reference compatible with a given motor vehicle model among a plurality of windshield wipers 3 on the shelving 5, for example stored on stock display prongs 7 on the shelving 5.

The method may be implemented with the aid of a searching system 1 as described previously.

Such a method makes it possible to cause the compatible windshield wiper 3 reference(s) to illuminate or to flash when at least one identification parameter is input, i.e. allowing the identification of a car model.

To this end, the method comprises a first step El in which, via at least one search interface 9, at least one parameter identifying a motor vehicle model for which at least one windshield wiper 3 is being sought is input. More precisely, it is a user who performs this first step.

If one or more users are carrying out a search via the interface of their mobile terminals 17a, the method advantageously comprises a preliminary step of implementing, or connecting to, the application dedicated to searching for windshield wipers 3.

A plurality of input steps El may be performed via a plurality of search interfaces 9 simultaneously or in a short period of time, as is shown schematically by the representations of the search interfaces 9 in solid and broken lines in FIG. 2b.

The method comprises a second step E2 of interrogating the database(s) 13. This second step E2 makes it possible to identify at least one windshield wiper 3 reference compatible with the motor vehicle model of which at least one identification parameter has been input in step E1, in other words with the motor vehicle model of which the identity has been established with the aid of the one or more identification parameters.

This second, interrogation step E2 may comprise a sub-step for converting the identification parameter(s) of the motor vehicle model that has been input into a request format for extraction of at least one windshield wiper 3 reference compatible with the motor vehicle model identified with the aid of the one or more identification parameters.

According to a variant, the second step E2 of interrogating the database(s) 13 may be preceded by a step E20 of communication between the search interface 9 and the control unit 11. In this step E20, the search interface 9 may transmit the or each identification parameter such that the latter has been input in the first step E1 or converted into a request format. Interrogation step E2 may then be performed by a processing means 21 of the control unit 11 for communicating with the database(s) 13.

According to another variant, the second, interrogation step E2 may be performed directly by means for communication between the search interface 9 and the database(s) 13.

If the search interface 9 belongs to a fixed terminal 17b, such as an interactive terminal (see FIG. 3b), a single search is performed each time. In this case, a single step E2 of interrogation of the database(s) 13 is performed each time.

According to the alternative in which a plurality of users can carry out a plurality of searches simultaneously or in a short predefined period of time from their cellular telephones 17a (see FIG. 2b), a plurality of steps E2 of interrogating the database(s) 13 may be performed simultaneously or in the predetermined period of time.

In this case, the method may advantageously comprise a step of counting and storing the number of interrogations performed simultaneously or in the predefined period of time.

At the end of the or each second, interrogation step E2, at least one windshield wiper 3 reference compatible with the motor vehicle model of which the identity has been established with the aid of the one or more identification parameters at the time of the or each search performed from a search interface 9 is identified. This identification may be carried out by the processing means 21 of the control unit 11 or, optionally, of the search interface 9, configured such as to communicate with the database(s) 13.

According to a particular embodiment, at least two references, for example three references, of windshield wipers 3 of different ranges, A, B, C are identified (see FIG. 4) at the end of the or each of second step E2.

In a third step E3 (see FIGS. 1, 2b, 3b), at least one information item associated with the identified reference may be sent to the search interface 9 or to each search interface 9 from which a search has been performed. This step E3 may be performed by at least one processing means 21 of the control unit 11.

In particular, when a plurality of searches are performed simultaneously or in a short predefined period of time, the method may comprise a sub-step of determining and attributing signaling parameters specific to each request. This step is performed by at least one processing means 21 of the control unit 11.

This makes it possible to distinguish the stock display prong 7 bearing the correct windshield wiper 3 references or, directly, the windshield wipers 3 for each user by means of different colors and/or different flashing rates.

An information item relating to the signaling parameters may also be sent to each search interface 9. In other words, at least one information item relating to the color and/or the flashing of the light-emitting diode 152 of the signaling device 15 may be sent, at the third step E3, to the display screen 19 of the search interface 9. This information item may be displayed on the search screen 19 alongside the display of the windshield wiper 3 reference.

The method also comprises a fourth step E4 in which the control unit 11 detects the signaling device 15 borne by the packaging 25 of the windshield wipers 3 and/or borne by the shelving 5, notably borne by the stock display prong 7 storing the windshield wipers 3 having the reference(s) identified after interrogation of the database(s) 13.

This detection step E4 is performed by the processing means 23 of the control unit 11, such as an RFID reader. According to an illustrative embodiment, in step E4 the RFID reader of the control unit 11 emits radiofrequencies such as to communicate with the radio identification marker belonging to the identification data support 151.

When a signaling device 15 is detected in step E4, the light-emitting device 152 is controlled or commanded so that it illuminates or flashes in a fifth step E5. The luminous signal is emitted in accordance with predefined timing. Thus, a user is able easily to locate the windshield wipers 3 of the reference(s) identified that may be used for the model of his/her motor vehicle.

To this end, the control unit 11 may send a control signal to command the light-emitting diodes.

In particular, the control unit 11 may command the light-emitting devices 152, such as the light-emitting diodes, such that they emit a luminous signal that differs according to the windshield wiper 3 reference. The control signal may comprise a different color and/or rate information item depending on the windshield wiper 3 reference.

By way of example, if windshield wiper 3 references of different ranges A, B, C (see FIGS. 1 and 4) are identified at the end of step E2, the control unit 11 may, in step E5, command the light-emitting devices 152, such as the light-emitting diodes, associated with the windshield wiper 3 references of different ranges such that they emit a luminous signal that differs according to range. For example, the light-emitting diodes emit a different color light and/or flash at different flashing rates.

However, notably if no light-emitting device 152 is emitting a luminous signal or if the stock display prong(s) 7 for which a light-emitting device 152 is emitting a signal is free/empty, the user is able to note the absence of a windshield wiper 3 for the identified reference on the shelving 5.

Naturally, the order of certain steps in this method may be interchanged.

The user may thus take a windshield wiper 3 signaled by virtue of this method, i.e. for which the light-emitting diode on the packaging 25 of the windshield wiper 3 and/or on the shelving 5, for example on the stock display prong 7, is illuminated or flashing.

In the event of doubt, the user can naturally scan the windshield wiper 3 reference in order to verify that this is indeed the reference or one of the references displayed on the display screen 19 of his/her cellular telephone 17a or of the interactive terminal 17b. This makes it possible to assure the user as to his/her choice and to dispel any doubt he/she may have regarding the purchase of the correct windshield wiper 3 reference required.

Furthermore, when the search is performed from a mobile terminal 17a of the user, provision may be made for a supplementary step of recording the reference(s) compatible with the user's motor vehicle model. In the event of this user subsequently passing close to the windshield wipers 3, and if the search application is activated on the mobile terminal 17a, provision may be made for a supplementary step of communication between the mobile terminal 17a of the user and the control unit 11, followed by a step of controlling the illumination or flashing of the light-emitting devices 152 associated with the windshield wiper 3 references identified previously.

Thus, when at least one identification parameter making it possible to identify a car model is input on a cellular telephone 17a or an interactive terminal 17b, one or a plurality of databases 13 are interrogated. The control unit 11 may detect the windshield wipers 3 that correspond to the user's motor vehicle model by reading information items from the support of identification data borne by the packaging 25 of the windshield wipers 3 and/or by the shelving 5, notably on the stock display prongs 7, and command the illumination of the corresponding light-emitting diode. This thus enhances the service provided for clients in the store, who benefit from visual signaling of the correct references for windshield wipers 3 stored on the shelving 5 of the store, or who may, conversely, rapidly note the absence of these references on the shelving 5.

It is likewise possible to visualize the references and their color and/or flashing rate on the display screen 19 of the cellular telephone 17a or interactive terminal 17b. The different ranges of the windshield wiper 3 references identified may, for example, be displayed with different signage on the display screen 19.

1. A method for signaling at least one windshield reference that is compatible with a given motor vehicle model among a plurality of windshield wipers stored on a shelf, with the aid of a windshield wiper reference searching system, comprising:
providing at least one search interface, and
providing at least one database of data relating to the windshield wiper references on the shelf and their compatibility with a plurality of motor vehicle models,
said method comprising the following steps:
performing step (E1) wherein at least one identification parameter of a motor vehicle model for which at least one windshield wiper is sought is input via said at least one search interface,
performing step (E2) wherein said at least one database is interrogated such as to identify at least one windshield wiper reference compatible with the motor vehicle model of which the identity was established with the aid of said at least one identification parameter,
performing step (E3) wherein at least one information item relating to said at least one windshield wiper reference identified is sent to the search interface,
characterized in that said method further comprises the following steps:
performing step (E4) wherein at least one signaling device borne by the windshield wiper of the identified reference and/or borne by the shelf is detected, said at least one signaling device comprising a light-emitting device, and
performing step (E5) wherein the light-emitting device of said at least one detected signaling device is controlled such that it emits at least one luminous signal enabling a user to locate the windshield wiper of the identified reference or to note the absence on the shelf of a windshield wiper of the identified reference.

2. The method as claimed in claim 1, wherein the step (E4) of detecting said at least one signaling device and the step (E5) of controlling the light-emitting device are implemented by a control unit of the searching system.

3. The method as claimed in claim 1, wherein the step (E2) of interrogating said at least one database and the step (E3) of sending at least one information item to the search interface are implemented by the control unit of the searching system.

4. The method as claimed in claim 1 wherein the light-emitting device is controlled such that it flashes.

5. The method as claimed in claim 1, wherein:
which the identity has been established with the aid of said at least one identification parameter, and which are from different ranges (A, B, C), are identified, and
the light-emitting devices of the signaling devices associated with the references of windshield wipers in the different ranges are controlled such that they emit a different luminous signal in accordance with the range (A, B, C).

6. The method as claimed in any claim 1, comprising a plurality of steps of inputting via a plurality of search interfaces and a plurality of steps of interrogating said at least one database, and wherein:
at each interrogation step (E2), at least one windshield wiper reference compatible with the motor vehicle model of which the identity has been established with the aid of said at least one identification parameter is identified,
at least one information item relating to the identified reference is sent to the associated search interface, and
the light-emitting devices are controlled such that they emit a different luminous signal in accordance with the reference.

7. The method as claimed in claim 5, wherein the light-emitting devices emit luminous signals in different colors, and wherein at least one information item relating to the color associated with at least one windshield wiper reference is displayed on the search interface.

8. The method as claimed in claim 4, wherein the light-emitting devices emit luminous signals at different flashing rates, and wherein at least one information item relating to the flashing rate associated with at least one windshield wiper reference is displayed on the search interface.

9. The method as claimed in claim 1, for signaling at least one windshield wiper reference compatible with a given motor vehicle model among a plurality of windshield wipers stored on stock display prongs on the shelf, and wherein, in detection step (E4), at least one signaling device borne by a stock display prong dedicated to storing windshield wipers of the identified reference is detected.

10. A system for searching for windshield wiper references compatible with a given motor vehicle model among a plurality of windshield wipers on a shelf, the searching system being configured such as to implement the method of claim 1, and comprising:
at least one search interface configured for the inputting of at least one identification parameter of a motor vehicle model for which a user is seeking at least one windshield wiper, and
at least one database of data relating to the windshield wiper references on the shelf and their compatibility with a plurality of motor vehicle models,
characterized in that the searching system further comprises:
a control unit comprising at least one processing means:
for communicating with said at least one search interface and said at least one database such as to identify at least one windshield wiper reference compatible with the motor vehicle model of which the identity has been established with the aid of said at least one identification parameter,
for communicating with a plurality of signaling devices borne by the windshield wipers and/or by the shelf such as to detect at least one signaling device of the identified reference, and
for commanding a light-emitting device of said at least one detected signaling device.

11. The searching system as claimed in claim 10, wherein the search interface belongs to a mobile terminal.

12. The searching system as claimed in claim 10, wherein the search interface belongs to a fixed terminal of the interactive terminal type.

13. Packaging configured such as to receive a windshield wiper for a motor vehicle and such as to be stored on a shelf, characterized in that the packaging comprises a signaling device, the signaling device comprising an identification data support and at least one light-emitting device, such that:
the identification data support (151) comprises at least one information item on the windshield wiper (3) reference, and
the light-emitting device (152) is configured to emit a luminous signal such as to enable a user to locate the windshield wiper (3) of this reference.

14. The packaging as claimed in claim 13, wherein the signaling device is integrated into an anti-theft security device affixed to the packaging of the windshield wiper.
